(19) United States
(12) Patent Application Publication
(10) Pub. No.: US 2003/0165606 A1
(43) Pub. Date: Sep. 4, 2003

(54) Anti-regurgitation formula and uses thereof

(76) Inventors: John B. Lasekan, Worthington, OH (US); Julia A. Byard, Columbus, OH (US); Mary P. Franz, Johnstown, OH (US); Hawley K. Linke, Upper Arlington, OH (US)

Correspondence Address: ROSS PRODUCTS DIVISION OF ABBOTT LABORATORIES, DEPARTMENT 108140-DS/1, 625 CLEVELAND AVENUE, COLUMBUS, OH, 43215-1724, US

(21) Appl. No.: 10/193,516

(22) Filed: Jul. 11, 2002

Related U.S. Application Data
(60) Provisional application No. 60/306,304, filed on Jul. 18, 2001.

(51) Int. Cl. C12C 1/00

(52) U.S. Cl. 426/590

(57) ABSTRACT

It has been discovered that reducing the amount of lactose in standard non-soy protein based infant formulas will help to alleviate the regurgitation that is commonly experienced by infants during the first six to twelve months of life. Lactose levels should be 75 wt/wt %, or less, of the carbohydrate component.

### CROSS REFERENCE

This application is related to the U.S. provisional application Serial No. 60/306,304, which was filed on Jul. 18, 2001.

### FIELD OF THE INVENTION

The present invention relates to a non-soy protein-based infant formula having reduced lactose content and to its use in reducing regurgitation in infants. Further aspects of the invention are directed to methods of providing nutrition to an infant predisposed to regurgitation.

### BACKGROUND

Regurgitation (spit-up) is a common problem in infants, affecting up to 50% of all infants at 2 months of age. The peak incidence of spit-up typically occurs around 3-4 months of age, impacting up to 67% of the population. Typically, the problem spontaneously resolves itself between the ages of 6 months and one year.

Regurgitation results from the immaturity of the cardioesophageal sphincter (the muscle that seals off the stomach from the esophagus). The sphincter may take 6 months, or more, to become fully competent. Thus, if an infant's stomach is overly full, or if her position is abruptly changed during feeding, the partially digested contents of the stomach can press the sphincter open and flood back through the esophagus and into the mouth. Regurgitation refers to this effortless return of the stomach's contents to, and often out of, the infant's mouth.

The majority of infants experience regurgitation and this is accepted by most caregivers as being a normal, although sometimes inconvenient feature of infancy. However, inexperienced or stressed caregivers may have difficulty coping with the problem. This has lead to the search for means of ameliorating regurgitation.

Physicians and caregivers may invoke a variety of feeding and post feeding techniques to treat spit-up. These include reduction in manipulations of the infant soon after feeding, lower volume and more frequent feedings, prone sleeping positions, burping after feeding and formula switching. For some infants, these behavior changes may improve spit-up frequency and/or volume, but they are not reliable. In extreme cases, spit-up advances and begins to damage the infant's esophagus. In those circumstances, physicians turn to medication and/or surgery.

Some researchers have focused upon the infant formula itself and whether its composition can impact regurgitation. Since the problem is directly related to immaturity and gravity, increasing the viscosity of the infant formula has been evaluated. Vandenplas et al demonstrated a reduction in regurgitation when the formula was thickened with carob bean gum. Clinical Pediatrics, Vol. 26, No. 2, (1987). Orenstein et al demonstrated that infant formula thickened with rice cereal reduced spit-up in infants. Journal of Pediatrics Vol. 110, No. 2 (1987). Similar results with rice cereal were demonstrated by Ramenofsky et al, in Journal of Pediatric Surgery, 16:374 (1981) and Vanderhoof et al, in Pediatric Research 45:118A (1999).

Others have evaluated the impact of different protein sources upon spit-up. Tolia et al evaluated the incidence of spit-up in a group of infants alternatively consuming casein-based, soy-based and whey-based formulas. Journal of Pediatric Gastroenterology and Nutrition 15:297-301 (1992). They reported that soy appeared to produce less spit-up than casein, but the observed differences did not reach statistical significance.

All infant formulas contain at least one source of carbohydrate, since these compounds serve as a major source of energy for the infant. In milk-based formula, lactose is the predominant source of carbohydrate. Lactose is a disaccharide, composed of glucose and galactose. In humans, the enzyme lactase cleaves the disaccharide so that the individual glucose and galactose molecules can be efficiently absorbed. In addition to serving as an energy source, lactose also promotes the absorption of calcium.

Heubi et al reported a multi-center trial in which the efficacy and safety of lactose-free formula was evaluated. Pediatric Research, Vol. 100, Number 2, (2000). This trial compared two different milk protein-based formulas, in which the source of carbohydrate was lactose or maltodextrin and sucrose. The report shows that one of the most common adverse events in each group was spit-up. In fact on page 215, in Table 4, Huebi et al, reports virtually identical rates of spit-up for both formulas.

Thus, while the literature reports that either elevated viscosity or soy protein may reduce the incidence of regurgitation, there are no reports of any attempt to evaluate the impact of lactose upon regurgitation. In fact, the literature discussing lactose-free formulas suggests that lactose is immaterial to the incidence of spit-up in healthy term infants.

### SUMMARY OF THE INVENTION

In accordance with the present invention, it has been discovered that reducing the amount of lactose in an infant formula will alleviate the regurgitation that is commonly experienced by infants during their first year of life. While previous researchers have not documented that lactose has any impact upon regurgitation, we have demonstrated such a correlation in human infants. In seven (7) clinical studies, a consistent reduction in spit-up was observed, when lactose was either removed, or reduced by at least 50%, in milk protein-based and rice protein-based formulas. These formulations were accomplished by simply using a lactose-free or a lactose reduced protein source.

The infant formulas utilized in the present invention contain non-soy based-protein, carbohydrate, lipid, vitamins and minerals, as is known in the art. Typically, the protein sources are milk-based proteins. These nutrients should be present in quantities sufficient to optimize infant growth and development. Such an effect, along with a clinically significant reduction in regurgitation, can be accomplished by feeding an infant a formula containing, per 100 kcal:

a) about 1 to 3.5 grams of protein obtained from non-soy based protein source;

b) about 3 to 8 grams of lipid, and;

c) about 8 to 16 grams of carbohydrate, in which no more than about 75% of said carbohydrate is lactose, based upon the total weight of the carbohydrate present in the formula.

In one preferred embodiment of the invention, the lactose is no more than about 50% of the total carbohydrate; in a further embodiment, the lactose is no more than about 10% of the total carbohydrate; in a preferred embodiment, the formula is lactose-free.

In a further embodiment of the invention, the ready-to-feed viscosity of the formula can be increased. While reducing lactose will typically ameliorate regurgitation, it has been discovered that some infants benefit from the combination of reduced lactose and increased viscosity. The reduced lactose formula described above can be thickened by incorporating a viscosity-increasing agent. A sufficient quantity should be utilized to raise the ready-to-feed viscosity to at least 20 centipoise. If desired, thickening agents, such as starch, can be utilized. Such agents produce an additional significant increase in the viscosity of the formula in an acidic environment, such as the infant's stomach.

### DETAILED DESCRIPTION OF THE INVENTION

As used in this application, the following terms have the meanings defined below, unless otherwise specified. The plural and the singular should be treated as interchangeable:

a) the term “regurgitation” refers to the effortless retrograde movement of the gastric contents into the esophagus, and at times the mouth.

b) the term “vomiting” refers to the forceful expulsion of the stomach's contents into the mouth, which is caused by the contraction of the abdominal and diaphragm muscles

c) the term “infant” refers to a child aged 1 year, or younger.

d) the term “lactose-free” refers to an infant formula that contains no more than about 200 ppm, or about 30 milligrams of lactose per 100 kcal as determined by High Performance Liquid Chromatography. Samples are weighed directly into a 100 ml volumetric flask and brought to volume with water for a total dilution of 1:5. Samples are mixed well by inversion, and approximately 3 ml of each sample is filtered through a PTFE syringe filter (Titan disposable 0.45 μm PTFE membrane syringe filters, 25 mm in size from Scientific Resources, Inc.) with a pore size of 0.45 um. The filter partially clarifies the sample and retains possible interfering substances, such as proteins and fats. The filtrate is directly analyzed by ion chromatography using gradient elution with varying concentrations of sodium hydroxide and sodium acetate on Dionex Carbo-Pac PA-10 anion-exchange columns. Lactose is detected by integrated pulsed amperometric detection (PAD) and quantitated using a four-point quadratic calibration curve. As an alternative to the quantitative determination, the method may be used as a limit test by comparing samples to the response for a single standard that corresponds to the desired limit.

e) any reference to a numerical range in this application should be construed as an express disclosure of every number specifically contained within that range and of every subset of numbers contained within that range. Further, this range should be construed as providing support for a claim directed to any number, or subset of numbers in that range. For example, a disclosure of 1-10 should be construed as supporting a range of 2-8, 3-7, 5, 6, 1-9, 3.6-4.6, 3.5-9.9, 1.1-9.9, etc.

f) the term “infant formula” as used herein refers to a nutritional composition designed for children 1 year, or younger, which contains sufficient protein, carbohydrate, fat, vitamins, minerals, and electrolytes to serve as the sole source of the nutrition for these children, when provided in a sufficient quantity. The composition may be a ready-to-feed liquid, a concentrate that is diluted prior to consumption or a powder that is reconstituted prior to consumption.

g) the term “milk-based protein” refers to any source of milk protein suitable for consumption by infants, such as bovine, goat, etc.

h) any reference in the specification or claims to a viscosity in centipoise should be construed as having been measured on a Brookfield DVII+ Viscometer or equivalent using an LV spindle #3 at 60 rpm at room temperature, unless specified otherwise.

i) the term “non-soy based protein” refers to any protein that is suitable for consumption by infants that is not derived, extracted, isolated or concentrated from soybeans.

j) the terms “regurgitation”, and “spit-up” are being used interchangeably within this application and refer to a common physiological process as described above. Thus, within the specification or claims, they should be considered as synonyms. For the purposes of this application, the term “vomiting” should be considered to be synonymous to spit-up. While the physiological mechanisms of spit-up and vomiting are different, caregivers often fail to recognize the difference and report both as spit-up and/or as vomiting.

As noted above, the key to the present invention is the unexpected discovery that limiting the quantity of lactose in infant formula will reduce, or eliminate, spit-up in infants. In typical milk protein-based infant formulas, lactose comprises essentially 100% of the carbohydrate content of the formula. We have discovered that a clinically significant reduction in spit-up can be accomplished by using milk-based formulas, if the lactose content is reduced by a factor of at least 25%, based upon the total weight of carbohydrate contained in the formula. Thus in the formulas of this invention, lactose will comprise no more than 75% of the total carbohydrate content of the formula, based upon the total weight of carbohydrate contained in the formula. Preferably, the lactose content will be reduced by at least 50%, more preferably, the lactose content will be reduced by at least 90%, and most preferably, the formula will be lactose-free, based upon the total weight of carbohydrate contained in the formula.

A reduction in spit-up can be accomplished using infant formula that is identical to those currently known in the art. The formulas of this invention may be provided in powdered, liquid concentrate or ready-to-feed forms. Before feeding, water is added to both the powdered and concentrated forms of the formula. In a first embodiment, an infant formula of the invention contains, based on a 100 kcal basis, about 8 to about 16 grams of carbohydrate (preferably about 9 to about 13 grams), about 3 to about 8 grams lipid (preferably about 4 to about 6.6 grams), and about 1 to about 3.5 grams of protein (preferably about 1.5 to about 3.4 grams). As noted above, lactose content will be reduced by at least 25%, based upon the total weight of carbohydrate contained in the formula. Thus, a formula containing 16 grams of carbohydrate per 100 kcal will contain at most 12 grams of lactose. If the formula contains 8 grams of carbohydrate per 100 kcal, it will contain at most 6 grams of lactose. More preferably, the formula will be lactose-free and thus will contain no more than about 200 ppm, or about 30 milligrams of lactose per 100 kcal.

As noted above, the formulas can be manufactured in any of the forms currently known to those skilled in the art (i.e. powder, liquid concentrate, or ready-to-feed). A summary of the carbohydrate, lipid, and protein content for these different types of formula is provided in Table 1 below. The lactose content of any of these formulas will constitute at most 75% of the carbohydrate content, preferably about 50% of the carbohydrate content, more preferably about 10% and most preferably will be considered lactose-free.

TABLE 1
Ranges of Carbohydrate, Lipid and Protein

| | | | gram/ | gram/liter |
|---|---|---|---|---|
| | | gram/ | 100 gram | (as fed |
| Nutrient | Range | 100 kcal | powder | concentration) |
| Carbohydrate | Broadest | 8-16 | 30-90 | 54-108 |
| | Preferred | 9-13 | 45-60 | 61-88 |
| Lipid | Broadest | 3-8 | 15-35 | 20-54 |
| | Preferred | 4-6.6 | 20-30 | 27-45 |
| Protein | Broadest | 1-3.5 | 8-17 | 7-24 |
| | Preferred | 1.5-3.4 | 10-17 | 10-23 |

The key to the present invention is the carbohydrate system. Carbohydrates must be included in infant formula since they are a major source of readily available energy that the infant needs for growth, metabolism, etc. In human milk, and most standard milk-based infant formulas, the sole source of carbohydrate is lactose. In order to obtain the benefits described above, this lactose content must be reduced by at least 25%, based upon the total weight of carbohydrate contained in the formula.

Since infants require carbohydrate, alternative sources must be incorporated into the formula to replace the lactose. Any carbohydrate that is considered suitable for consumption by human infants may be utilized to replace the lactose (i.e., a gram per gram replacement). Examples of suitable carbohydrates include hydrolyzed or intact, naturally and/or chemically modified starches sourced from corn, tapioca, rice or potato, in waxy or non-waxy forms. Other examples of carbohydrates include hydrolyzed cornstarch, maltodextrin, glucose polymers, sucrose, corn syrup, corn syrup solids, glucose, fructose, high fructose corn syrup and indigestible oligosaccharides, such as fructooligosaccharides (FOS). Any single carbohydrate listed above, or any combination thereof, as appropriate may be utilized. Other suitable carbohydrates will be readily apparent to those skilled in the art.

Commercial sources for the carbohydrates listed above are readily available and known to one practicing the art. For example, corn syrup solids are available from Cerestar USA, Inc in Hammond, Ind. Rice based syrups are available from Remy Industries S.A. in Wijgmaal-Leuven, Belgium. Various corn syrups and high fructose corn syrups are available from Cargil in Minneapolis, Minn. Fructose is available from A.E. Staley in Decatur, Ill. Maltodextrin, glucose polymers, and hydrolyzed cornstarch are available from American Maize Products in Hammond, Ind. Glucose and sucrose are available from Domino Sugar Corp. in New York, N.Y. Indigestible oligosaccharides, such as FOS, are available from Golden Technologies Company of Golden, Colo.

Infants also require lipids for optimal growth and development. Lipids provide energy, promote the absorption of fat-soluble vitamins, and provide the essential fatty acids that are required for normal growth and development. Any lipid that is suitable for consumption by a human infant may be utilized in the present invention. Examples of suitable lipids include coconut oil, soy oil, corn oil, olive oil, safflower oil, high oleic safflower oil, MCT oil (medium chain triglycerides), sunflower oil, high oleic sunflower oil, palm oil, palm olein, canola oil, and mixtures thereof.

A more preferred source of lipid is an admixture of high oleic safflower oil, soy oil, and coconut oil. Especially preferred lipids include a blend of vegetable oils containing about 38-50 weight percentage high oleic safflower oil (HOSO), about 26-40 weight percentage soy oil (SO) and about 22-36 weight percentage coconut oil (CO). These oils blend produce softer stools and enhance bone mineralization. They have been described in detail in U.S. patent application Ser. No. 60/286,140 filed Apr. 24, 2001, U.S. Pat. No. 6,136,858 and U.S. Pat. No. 6,248,784, the contents of each are hereby incorporated by reference.

In addition to these vegetable oils, the formula may also contain arachidonic acid, docosahexaenoic acid, and mixtures thereof. Such lipids have been shown to have beneficial effects in infants, including enhanced brain and vision development. U.S. Pat. No. 5,492,938 to Kyle et al. describes these effects in detail. Lipid sources of arachidonic acid and docosahexaenoic acid include, but are not limited to, marine oil, egg derived oils, fungal oil and algal oil. Marine oil is available from Mochida International of Tokyo, Japan. DHA is available from Martek Biosciences Corporation of Columbia, Md. Arachidonic acid is available from Genzyme Corporation of Cambridge, Mass.

Infant formula must also contain protein. Protein is needed for growth and for the synthesis of enzymes, hormones, etc. The proteins utilized in this invention will be non-soy based sources and preferably milk-based protein sources depleted of inherent lactose. Examples of such proteins include casein, whey, whey protein concentrate, condensed skim milk, nonfat milk, hydrolyzed caseinates, hydrolyzed whey, milk proteins, mineral enriched milk proteins, milk protein isolate, rice protein, pea protein, potato protein, corn protein, hydrolyzed meat or collagen protein, and free amino acids. Typically, the protein sources will be milk protein. The invention should also be construed as including those formulas in which the proteins are supplemented with free amino acids. Examples of such amino acids include tryptophan, glutamine, tyrosine, methionine, cystein, and arginine.

Commercial sources of these proteins are readily available and known to one practicing the art. For example, caseinates, whey, hydrolyzed caseinates, hydrolyzed whey and milk proteins are available from New Zealand Milk Products of Harrisburg, Pa. Corn protein is available from Grain Processing Corporation of Muscatine, Iowa. Rice protein is available from California Natural Products of Lathrop, Calif. Pea protein is available from Feinkost Ingredient Company of Lodi, Ohio. Hydrolyzed collagen protein is available from Kraft Food Ingredients of Memphis, Tenn.

Infant formula must also contain vitamins and minerals in amounts designed to supply the daily nutritional requirements of an infant. The formula preferably includes, but is not limited to, the following vitamins and minerals: phosphorus, sodium, chloride, magnesium, manganese, iron, copper, zinc, selenium, iodine, and Vitamins A, E, C, D, K and the B complex. Further nutritional guidelines for infant formulas can be found in the Infant Formula Act, 21 U.S.C. sections 350(a). The nutritional guidelines found in the Infant Formula Act continue to be refined as further research concerning infant nutritional requirements is completed. This invention is intended to encompass formulas containing vitamins and minerals and other nutrients that may not currently be listed in the Act.

The infant formulas of this invention may optionally contain a stabilizer. Suitable stabilizers for use in pediatric nutritionals are well known to those skilled in the art. Suitable stabilizers include, but are not limited to, gum arabic, gum ghatti, gum karaya, gum tragacanth, agar, furcellaran, guar gum, gellan gum, locust bean gum, xanthan gum, pectin, low methoxyl pectin, gelatin, microcrystalline cellulose, CMC (sodium carboxymethylcellulose), methylcellulose, hydroxypropyl methyl cellulose, hydroxypropyl cellulose, DATEM (diacetyl tartaric acid esters of mono- and diglycerides), dextran, carrageenans, and mixtures thereof. The amount of stabilizers utilized will vary depending upon the stabilizer(s) selected, the other ingredients present, and the stability and viscosity of the formula that is sought. Appropriate amounts can be determined by those of skill in the art based on the particular characteristics (e.g., viscosity, shelf life, acceptable sedimentation rates) being sought in the formula.

Prior to the inventors work, it was generally believed in the industry that the only way to reduce regurgitation in milk protein-based formula was to significantly increase the viscosity of that formula. This was generally accomplished by using gums such as carob gum or starches such as rice starch. Orrenstein et al, supra, and Vanderhoof, supra, describe these formulas in detail.

Thus, one of the advantages of this invention is that it is now possible to ameliorate regurgitation with a formula having a normal viscosity (i.e., in the range of 2-10 centipoise). This can be accomplished by simply reducing lactose levels as described above.

Infants who will benefit from such a result include any infant who has an incidence of regurgitation thought by his caretaker to be excessive, such as healthy full term infants, infants with protein intolerance, infants with gastroesophageal developmental delay or malfunction, and infants of low birth weight due to prematurity or reduced uterine growth.

However, it is important to emphasize that the invention should not be construed as being limited to standard viscosity formulas. It has also been discovered that in certain infants, a further reduction in regurgitation can be obtained by increasing the viscosity of the infant formula. Thus, the invention should also be considered to encompass a non-soy protein-based infant formula having an elevated viscosity, in combination with reduced lactose content.

These elevated viscosity infant formulas will contain, based on a 100 kcal basis:

a) about 1 to 3.5 grams of a protein obtained from non-soy protein sources;

b) about 3 to 8 grams of lipid, and;

c) about 8 to 16 grams of a carbohydrate system in which

i. no more than 75% of said carbohydrate is lactose, based upon total weight of carbohydrate present in the formula and;

ii. said carbohydrate includes a sufficient quantity of a viscosity-increasing agent.

The elevated viscosity formulas will be similar to the reduced lactose formulas described above. They may be utilized as a liquid concentrate, a powder, or as ready-to-feed. The relative amounts of carbohydrate, lipid, and protein will match that described in Table I. The description above of suitable lipids, suitable proteins, vitamins, minerals, etc. is equally relevant to these thickened formulas and will not be repeated here. The only modification to the discussion above is the necessity to modify the carbohydrate content by incorporating a viscosity-increasing agent into the formula.

The carbohydrate system of the infant formula will include a viscosity-increasing agent. Thus, a portion of the 8 to 16 grams of carbohydrate in this formula will be one, or more, viscosity-increasing agents. The exact amount will vary depending upon the particular viscosity-increasing agent that is chosen.

Examples of suitable viscosity increasing agents include gums, such as locust bean gum, carob gum, xanthan gum, guar gum, alginate, konjac flour (glucomannan), beta-glucan, psyllium, carboxymethyl cellulose, fenugreek fiber, gum tragacanth, gum arabic, gellan gum, gum ghatti, gum karaya, furcellaran, gelatin, agar, pectin, carrageenan, microcrystalline cellulose, hydroxypropyl methyl cellulose. A sufficient quantity of thickening agent should be utilized so that the infant formula has a ready-to-feed viscosity of at least 20 centipoises. Ready-to-feed (RTF) viscosities in excess of 150 centipoise should be avoided, since infants may have trouble sucking such a formula through a standard infant nipple. As a general guideline, if a gum is utilized it will be present in an amount ranging from 0.1 to 1.0 grams per 100 kcal.

More preferably, the viscosity-increasing agent will be a starch. Suitable starches include tapioca, rice, corn, potato, amaranth starch, milo starch, cassava starch, arrowroot starch, sago starch, amioca starch and green pea starch. The starches may be waxy or non-waxy. Sufficient starch should be utilized to produce a RTF viscosity ranging between 20 centipoises and 150 centipoise as described above. This can be accomplished if 20-40% of the carbohydrate system is represented by one, or more, of these starches. For example, if the formula contains 8 grams of carbohydrate, the formula will contain from 1.6 to 3.2 grams of starch and a maximum lactose content of 6 grams.

As is well known to those skilled in the art, the starch must be heated in order to produce this viscosity increasing effect. This can be accomplished by food grade sterilization techniques such as retorting, pasteurization, or purchasing pregelatinized starches. The use of starches to prepare formula is described in detail in U.S. Pat. No. 6,099,871, the contents of which are hereby incorporated by reference.

A further advantage of starches and gums is their interaction with protein in the presence of acid, resulting in significant increases in viscosity. When exposed to pH's in the range of 1 to 5 (such as the infant stomach) they produce a significantly higher viscosity. Typically, viscosities will increase by a factor of 5 to 50 times. Thus, infant formula containing sufficient amounts of these starches or gums will produce viscosities in the range of 100 to 1000 cps when they are in an acid environment, such as the infant stomach.

Any of the infant formulas of this invention can be manufactured using techniques well known to those skilled in the art. Various processing techniques exist for producing powdered, ready-to-feed and concentrate liquid formulas. Typically, these techniques include formation of a slurry from one or more solutions that may contain water and one or more of the following: carbohydrates, proteins, lipids, stabilizers, vitamins and minerals. This slurry is emulsified, homogenized and cooled. Various other solutions may be added to the slurry before processing, after processing or at both times. The processed formula is then sterilized and may be diluted to be utilized on a ready-to-feed basis or stored in a concentrated liquid or a powder. If the resulting formula is meant to be a ready-to-feed liquid or concentrated liquid, an appropriate amount of water would be added before sterilization. If the resulting formula is meant to be a powder, the slurry will be heated and dried to obtain a powder. The powder resulting from drying may be dry blended or agglomerated with further ingredients, if desired.

In actual use, the formula of this invention may be consumed by any human. More specifically, the specified carbohydrate composition of this invention may be incorporated into a formula that complies with accepted levels of vitamins, minerals, micro-components and the like. The amount consumed does not differ from that associated with the normal consumption of commercially available infant formula. The caloric density (i.e., kcals/ml) and caloric distribution (i.e., the relative proportion of calories from fat, protein and carbohydrate) are not critical to this invention but are generally comparable to conventional formulas. As is well know to those skilled in the art, these factors can vary with the intended use of the formula. For example, pre-term, term and toddler infants have somewhat differing caloric density requirements. In addition, formulas for specific disease states (e.g., diabetes, pulmonary deficiency, in-born errors of metabolism, and immuno-comprised) will have differing caloric distributions. Those skilled in the art are aware of these differences and will readily adapt the present invention to meet those special needs.

The following examples are being presented in order to further illustrate the invention. While the invention is not intended to be limited to the examples below, as it is intended to encompass read-to-feed, powdered and concentrate liquid infant formulas and their use in providing nutrition to infants. The examples are not intended to be limiting as other carbohydrates, lipids, proteins, stabilizers, vitamins and minerals may be used without departing from the scope of the invention.

### EXAMPLE I

The following Example illustrates the preparation of a powder infant formula suitable for carrying out the method of the present invention. The components utilized in the formula are depicted in Table 2. The quantities outlined are used to prepare a 3,402 kg batch of powder.

TABLE 2
Bill of Materials

| INGREDIENT | AMOUNT | |
|---|---|---|
| High Oleic Safflower Oil | 401 | kg |
| Coconut Oil | 286 | kg |
| Soy Oil | 268 | kg |
| Ascorbyl Palmitate | 1.3 | kg |
| Beta carotene | 408 | g |
| Vitamin A Palmitate | 26 | g |
| Oil Soluble Vit Premix | 1.2 | kg |
| Tocopherol | 0.54 | kg |
| Milk Protein Isolate | 414 | kg |
| Calcium Phosphate Tribasic | 44 | kg |
| Calcium Carbonate | 0.54 | kg |
| Potassium Citrate | 37 | kg |
| Magnesium Chloride | 3.9 | kg |
| Potassium Chloride | 7.9 | kg |
| Lactose | 481 | kg |
| Maltodextrin | 481 | kg |
| Potassium Iodide | 5.1 | g |
| Corn Syrup | 1,202 | kg |
| Ferrous sulfate | 0.154 | kg |
| Water Soluble Vitamin/Trace | 5 | kg |
| Minerals/Taurine Premix | | |
| Choline Chloride | 0.63 | kg |
| Choline Bitartrate | 4.5 | kg |
| Nucleotides | 2.6 | kg |
| L-carnitine | 0.367 | kg |
| Riboflavin | 0.018 | kg |
| Ascorbic Acid | 5.4 | kg |

Prepare a slurry consisting of carbohydrates and minerals with sufficient water and heat to 145-155° F. under agitation. After addition of carbohydrates and minerals, hold slurry at 130-145° F.

Prepare a separate mixture of oils with agitation and heat to 160-175° F. Add lecithin, mono- and di-glycerides, oil soluble vitamins, carrageenan, and protein to the oils under agitation. Hold protein and oil slurry at 140-160° F.

Combine the carbohydrate and mineral slurry with the protein and oil slurry with sufficient water under agitation. The pH of the mixture is determined and if necessary, adjusted to 6.45 to 6.90 using KOH.

Process with high temperature short time (HTST) heat treatment temperature and sufficient (1500-4000 psi) homogenization pressure. Emulsify mixture through a single stage homogenizer at 900-1100 psi. After emulsification, hold the mixture at 165 to 185° F. for 16 seconds. Homogenize in a two-stage homogenizer at 3900-4100 psi and 400-600 psi. Cool the mixture to 34 to 45° F. Hold the mixture at 34 to 45° F. under agitation.

Make solutions containing water-soluble vitamins, trace minerals, free amino acids and nucleotides with sufficient water and add to the process mix.

Product is brought to a final solids concentration that is adequate for spray drying using conventional technology.

### EXAMPLE II

The following Example illustrates the preparation of a ready-to-feed infant formula suitable for carrying out the method of the present invention. The components utilized in the formula are depicted in Table 3. The quantities outlined are used to prepare a 34,020 kg batch of formula.

TABLE 3
Bill of Materials

| INGREDIENT | AMOUNT |
|---|---|
| High Oleic Sunflower Oil | 181 kg |
| Coconut Oil | 243 kg |
| Soy Oil | 243 kg |
| Palm Olein Oil | 545 kg |
| Lecithin | 12.1 kg |
| Mono- and diglyceride | 12.1 kg |
| Oil Soluble Vitamin Premix | 1.5 kg |
| Carrageenan | 10.2 kg |
| Non fat Milk Powder | 1445 kg |
| Rice Starch, waxy | 986 kg |
| Minerals Premix | 1.0 kg |
| Maltodextrin | 1490 kg |
| Ferrous sulfate | 2.0 kg |
| Water Soluble Vitamin/Taurine | 5.0 kg |
| Premix | |
| Choline Chloride | 2.14 kg |
| Ascorbic Acid | 11.9 kg |

To the non-fat milk is added maltodextrin and 5 minerals dissolved beforehand. The mixture is heated to 160° F. in a plate type heat exchanger. This is followed by the introduction of fats, which consist of palm olein, sunflower oil, coconut oil, soy oil, lecithin, mono- and di-glycerides and fat-soluble vitamins. The oils are melted before addition to the mixture. After preheating to about 170° F., the resulting mixture is homogenized in two stages, first at 1800 psi and then at 700 psi. Starch, vitamins, and minerals are added and the mixture is diluted to an equivalent of 20 Calories/oz. and sterilized in conventional retort or aseptic systems.

### EXAMPLE III

The following Example illustrates the preparation of a powder infant formula suitable for carrying out the method of the present invention. The components utilized in the formula are depicted in Table 4. The quantities outlined are used to prepare a 3,402 kg batch of powder.

TABLE 4
Bill of Materials

| INGREDIENT | AMOUNT | |
|---|---|---|
| High Oleic Safflower Oil | 401 | kg |
| Coconut Oil | 286 | kg |
| Soy Oil | 268 | kg |
| Ascorbyl Palmitate | 1.3 | kg |
| Beta carotene | 408 | g |
| Vitamin A Palmitate | 26 | g |
| Oil Soluble Vit Premix | 1.2 | kg |
| Tocopherol | 0.54 | kg |
| Milk Protein Isolate | 414 | kg |
| Calcium Phosphate Tribasic | 44 | kg |
| Calcium Carbonate | .54 | kg |
| Potassium Citrate | 37 | kg |
| Magnesium Chloride | 3.9 | kg |
| Potassium Chloride | 7.9 | kg |
| Sucrose | 372 | kg |
| Maltodextrin | 590 | kg |
| Potassium Iodide | 5.1 | g |
| Corn Syrup | 1,202 | kg |
| Ferrous sulfate | .154 | kg |
| Water Soluble Vitamin/Trace | 5 | kg |
| Minerals/Taurine Premix | | |
| Choline Chloride | 0.63 | kg |
| Choline Bitartrate | 4.5 | kg |
| Nucleotides | 2.6 | kg |
| L-carnitine | .367 | kg |
| Riboflavin | .018 | kg |
| Ascorbic Acid | 5.4 | kg |

A slurry consisting of sucrose and six mineral salts (tricalcium phosphate, choline chloride, potassium iodide, magnesium chloride, potassium citrate, potassium chloride) is prepared with sufficient water heated to 165-175° F. under agitation.

A separate mixture of soy oil, coconut oil and high oleic safflower oil are combined with agitation and heated to 135-155° F. Ascorbyl palmitate, beta-carotene, and oil soluble vitamins and tocopherols are added with agitation. The oil mixture is agitated and held at 130-150° F. until used.

Calcium carbonate and milk protein isolate are added to the oil blend and then combined with the sucrose mineral slurry, sufficient water and corn syrup under agitation. The pH of the mixture is determined and if necessary, adjusted to 6.45 to 6.90 using KOH.

The mixture is then processed with high temperature short time (HTST) heat treatment temperature and sufficient (1500-4000 psi) homogenization pressure. The preheated mixture is emulsified through a single stage homogenizer at 900-1100 psi, held at 165 to 185° F. for 16 seconds, and is then homogenized in a two stage homogenizer at 2400-2600 psi and 400-600 psi or 1400-1600 and 400-600 psi. The mixture and then cooled to 33 to 45° F. The mixture is held at 33 to 45° F. under agitation.

Solutions containing ferrous sulfate, water-soluble vitamins, trace minerals, taurine, carnitine, nucleotides, and choline bitartrate is added to the processed mix. Product is brought to a final solids concentration that is adequate for spray drying using conventional technology. Maltodextrin is dry blended into finished product using conventional technology. It is also proposed that the maltodextrin can be replaced with equivalent solids from pregelatinized rice starch.

### EXAMPLE IV

The following Example illustrates the preparation of a ready-to-feed infant formula suitable for carrying out the method of the present invention. The components utilized in the formula are depicted in Table 5. The quantities outlined are utilized to prepare a 34,020 kg batch of formula.

TABLE 5
Bill of Materials

| INGREDIENT | AMOUNT | |
|---|---|---|
| High Oleic Safflower Oil | 484 | kg |
| Coconut Oil | 363 | kg |
| Soy Oil | 363 | kg |
| Lecithin | 12.1 | kg |
| Mono- and diglyceride | 12.1 | kg |
| Oil Soluble Vit Premix | 1.5 | kg |
| Carrageenan | 10.2 | kg |
| Milk Protein Isolate | 542 | kg |
| Calcium Phosphate Tribasic | 28 | kg |
| Calcium Carbonate | 28 | kg |
| Potassium Citrate | 21 | kg |
| Magnesium Chloride | 13 | kg |
| Potassium Chloride | 22 | kg |
| Sucrose | 465 | kg |
| Rice Starch, medium grain | 774 | kg |
| Potassium Phosphate Monobasic | 24 | kg |
| Potassium Iodide | 6.5 | g |
| Corn Syrup | 1,499 | kg |
| Ferrous sulfate | 2.0 | kg |
| Water Soluble Vitamin/Trace | 6.0 | kg |
| Minerals/Taurine Premix | | |
| Choline Chloride | 1.9 | kg |
| Choline Bitartrate | 5.7 | kg |
| Nucleotides | 3.2 | kg |
| L-carnitine | 470 | g |
| Riboflavin | 23 | g |
| Ascorbic Acid | 11.9 | kg |

A slurry consisting of sucrose and six mineral salts (potassium phosphate monobasic, choline chloride, potassium iodide, magnesium chloride, potassium citrate, potassium chloride), and rice starch (medium grain, Remy Industries), is prepared with sufficient water heated to 130-150° F. under agitation. This slurry is processed under ultra high heat treatment (UHT) temperature and low (0-1000 psi) homogenization pressure to reduce the shear effect on the rice starch functionality. The mixture is emulsified at 300-500 psi, heated to 248-252° F. and then 299-303° F. for 5 seconds, and then homogenized in a two-stage homogenizer at 300-600 psi and 0-500 psi. The mixture is held at 165 to 185° F. for 16 seconds and then cooled to 33 to 45° F. After heat processing, the cooled mixture is held under agitation.

A separate mixture of soy oil, coconut oil and high oleic safflower oil are combined with agitation and heated to 165-175° F. The carrageenan, mono- and diglycerides and lecithin are added to the blend tank with agitation, followed by the calcium salts, protein, and oil soluble vitamins. The oil mixture is agitated and held at 130-160° F. until combining with sufficient water and corn syrup under agitation. The pH of the mixture is determined and if necessary, adjusted to 6.5 to 6.8 using KOH.

The oil/protein/calcium salt/corn syrup mixture is then processed under ultra high heat treatment (UHT) temperature and sufficient (1500-4000 psi) homogenization pressure. The mixture is emulsified at 900-1100 psi, heated to 248-252° F. and then 299-303° F. for 5 seconds, and then homogenized in a two-stage homogenizer at 3900-4100 psi and 400-600 psi. The mixture is held at 165 to 185° F. for 16 seconds and then cooled to 33 to 45° F. After heat processing, the oil blend/protein/calcium salt/corn syrup mixture is combined with the starch/sucrose/mineral slurry. The combined mixture is held at 33 to 45° F. under agitation.

Solutions containing ferrous sulfate, water-soluble vitamins, trace minerals, taurine, carnitine, nucleotides, and choline bitartrate is added to the processed mix.

Final dilution with water to meet specified levels of solids and caloric density is completed. The batch is then packaged in 32-ounce metal cans and sterilized using conventional technology.

### EXAMPLE V

The following Example illustrates the preparation of a ready-to-feed infant formula suitable for carrying out the method of the present invention. The components utilized in the formula are depicted in Table 6. The quantities outlined are used to prepare a 34,020 kg batch of formula.

TABLE 6
Bill of materials

| INGREDIENT | AMOUNT | |
|---|---|---|
| High Oleic Safflower Oil | 484 | kg |
| Coconut Oil | 363 | kg |
| Soy Oil | 363 | kg |
| Lecithin | 12.1 | kg |
| Mono- and diglyceride | 12.1 | kg |
| Oil Soluble Vit Premix | 1.5 | kg |
| Carrageenan | 10.2 | kg |
| Milk Protein Isolate | 542 | kg |
| Calcium Phosphate Tribasic | 28 | kg |
| Calcium Carbonate | 29 | kg |
| Potassium Citrate | 19 | kg |
| Magnesium Chloride | 11 | kg |
| Potassium Chloride | 23 | kg |
| Sodium Chloride | 1.1 | kg |
| Sucrose | 471 | kg |
| Rice Starch | 986 | kg |
| Potassium Phosphate Monobasic | 23 | kg |
| Potassium Iodide | 6.5 | g |
| Corn Syrup | 1,215 | kg |
| Ferrous sulfate | 2.0 | kg |
| Water Soluble Vitamin/Trace | 6.0 | kg |
| Minerals/Taurine Premix | | |
| Choline Chloride | 1.9 | kg |
| Choline Bitartrate | 5.7 | kg |
| Nucleotides | 3.2 | kg |
| L-carnitine | 470 | g |
| Riboflavin | 23 | g |
| Ascorbic Acid | 11.9 | kg |

A slurry consisting of rice starch, sucrose and seven mineral salts (potassium phosphate monobasic, choline chloride, potassium iodide, sodium chloride, magnesium chloride, potassium citrate, potassium chloride) is prepared with sufficient water heated to 130-150° F. under agitation.

A separate mixture of soy oil, coconut oil and high oleic safflower oil are combined with agitation and heated to 165-175° F. The lecithin and mono- and diglycerides are added to the blend tank with agitation, followed by the oil soluble vitamins and carrageenan. The oil mixture is agitated and held at 130-160° F. until used.

Calcium salts and protein are added to the oil blend and then combined with the starch/sucrose/mineral slurry plus sufficient water and corn syrup under agitation. The pH of the mixture is determined and if necessary, adjusted to 6.5 to 6.8 using KOH.

The combined mixture is then processed under ultra high heat treatment (UHT) temperature and sufficient (1500-4000 psi) homogenization pressure. The mixture is emulsified through a single stage homogenizer at 900-1100 psi, heated to 248-252° F. and then 299-303° F. for 5 seconds, and then homogenized in a two-stage homogenizer at 3900-4100 psi and 400-600 psi. The mixture is held at 165 to 185° F. for 16 seconds. After heat processing, the mixture is held at 33 to 45° F. under agitation.

Solutions containing ferrous sulfate, water-soluble vitamins, trace minerals, taurine, carnitine, nucleotides, and choline bitartrate is added to the processed mix.

Final dilution with water to meet specified levels of solids and caloric density is completed. The batch is then packaged in 32-ounce metal cans and sterilized using conventional technology.

### EXPERIMENT 1

A milk-protein based infant formula useful for the reduction of spit-up would offer broad applicability. The composition of such a formula was centered on a milk protein isolate specifically treated to be essentially devoid of lactose. The infant formula of the instant invention was manufactured and tested for efficacy in providing lower levels of spit-up, the ability to sustain normal patterns of infant growth, and performance among a variety of tolerance assessments.

The investigative formula (lactose-free) was nutritionally consistent with other standard formulas described for term infants except that the carbohydrate energy source was essentially devoid of lactose and contained 50% corn syrup, 30 % rice starch and 20% sucrose. The lactose-free formula offered 20 kcal per ounce, maintained a whey to casein ratio of 18:82, and met all Infant Formula Act requirements. The control formula, commercially available Similac® with Iron (SWI) (Ross Products, Columbus, OH), also offered 20 kcal per ounce, had a whey to casein ratio of 48:52, and 100% of its carbohydrate was supplied as lactose. The nutrient profile of the two formulas is listed in Table 7 below.

TABLE 7
Composition of test formulas (per liter)

| | | Control |
|---|---|---|
| Nutrient | Lactose-free | (SWI) |
| Protein, g | 15.1 | 14.0 |
| Source | milk protein isolate | nonfat milk, |
| | | whey protein |
| | | concentrate |
| Fat, g | 38.8 | 36.9 |
| Source | high-oleic safflower, | high-oleic safflower, |
| | soy, coconut oils | soy, coconut oils |
| Carbohydrate, g | 73.4 | 73 |
| Source | corn syrup, rice starch, | lactose |
| | sucrose | |
| Minerals | | |
| Calcium, mg | 692 | 546 |
| Phosphorus, mg | 439 | 310 |
| Magnesium, mg | 60.7 | 50.4 |
| Sodium, mg | 290 | 198 |
| Potassium, mg | 938 | 840 |
| Chloride, mg | 690 | 482 |
| Iron, mg | 15.3 | 13.3 |
| Zinc, mg | 7.5 | 5.1 |
| Copper, mg | 0.87 | 0.6 |
| Iodine, mg | 0.17 | 0.231 |
| Manganese, μg | 177 | 34 |
| Vitamins | | |
| A, IU | 2727 | 2997 |
| D, IU | 462 | 405 |
| E, IU | 22 | 22 |
| K₁, μg | 123.5 | 54 |
| C, mg | 251 | 229 |
| Thiamin, mg | 1.69 | 1.38 |
| Riboflavin, mg | 1.369 | 1.014 |
| Pyridoxine, mg | 0.599 | 0.472 |
| Niacin, mg | 1204 | 7095 |
| Vitamin B₁₂, μg | 7.11 | 1.69 |
| Folic acid, μg | 232 | 101 |
| Pantothenic acid, | 6.7 | 3.0 |
| mg | | |
| Biotin, μg | 82.5 | 30 |
| Taurine, mg | 45 | 45 |
| Choline, mg | 83 | 108 |
| Inositol, mg | 42 | 32 |
| Selenium, μg | 15 | 15 |

Underlined values are label claim, all others are analytical values.

Clinical data were analyzed from 264 normal term infants fed for approximately 4 months in a randomized, controlled, double blind, prospective study. At study entry, the infants were approximately 2 weeks of age and were randomized to one of two feeding groups (lactose-free formula or standard formula). The groups were indistinguishable in terms of birth weight, weight at entry into the study, other anthropometric parameters, gender and ethnicity. Infant anthropometric data and tolerance-associated responses to their assigned formula feedings were documented monthly. There were no differences between the feeding groups at any point during the study in regard to weight, length, head circumference, daily weight gain, amount of formula consumed, average number of stools per day, reasons for exiting the study, nor the number nor type of serious adverse events associated with formula consumption experienced.

On the other hand, data reported at monthly intervals on the frequency of spit-up associated with feedings did show significant differences. As is evident in Table 8 below, both data analyzed on an intent-to-treat basis and data collected from the evaluable groups only (composed of infants who completed the study according to protocol or with acceptable variations) clearly show the superiority of the lactose-free formula.

TABLE 8
Percentage of Feedings with Associated Spit-up/Vomit

| | | | |
|---|---|---|---|
| Approximate Age | Lactose-free | Control | p-value* |

Intent-to-Treat Population

| | | | |
|---|---|---|---|
| Study Visit 2 (28 days) | 11.0 ± 1.1 | 19.2 ± 1.9 | <0.0005 |
| Study Visit 3 (56 days) | 10.9 ± 1.8 | 17.8 ± 2.3 | 0.009 |
| Study Visit 4 (84 days) | 13.6 ± 2.3 | 19.3 ± 2.5 | 0.051 |
| Study Visit 5 (112 days) | 14.8 ± 2.0 | 19.1 ± 2.3 | 0.100 |

Evaluable Subgroup

| | | | |
|---|---|---|---|
| Study Visit 2 (28 days) | 10.5 ± 1.2 | 17.7 ± 2.0 | 0.002 |
| Study Visit 3 (56 days) | 10.7 ± 1.9 | 17.6 ± 2.3 | 0.008 |
| Study Visit 4 (84 days) | 13.7 ± 2.4 | 19.5 ± 2.5 | 0.049 |
| Study Visit 5 (112 days) | 14.7 ± 2.0 | 18.5 ± 2.2 | 0.122 |

| | |
|---|---|
| Repeated Measures^{†} | 0.001 |

Values are mean ± SEM
^{†}p-value is for the test of feeding group fixed effect from the repeated measures analysis

When repeated measures analysis was applied to all data collected, the lactose-free formula was associated with lower frequency of spit-up over the first 4 months of life; statistically significant at a p value equal to 0.001. The data also revealed that there was a greater percent of infants who were totally free of feeding associated and non-associated spit-up over the entire investigational period in the lactose-free formula feeding group (see Table 9).

TABLE 9
Percent of infants recording zero
spit-up during examination period

| | 1 month | 2 months | 3 months | 4 months |
|---|---|---|---|---|
| Lactose-free | 14 | 55 | 48 | 44 |
| Control | 6 | 35 | 34 | 32 |

Other tolerance related parameters were assessed based on information collected via parental diaries. When the lactose-free formula was compared to the SWI it was shown to be associated with slightly firmer stools and stools of generally lighter color. There are no medical implications associated with these differences.

Additional tolerance data was also obtained through parental questionnaires administered following the initial two weeks of study formula feeding. Results from these questionnaires are shown in Table 10 below. It is important to note that even on blinded recall, the parents recognized the lower spit-up frequency observed in their own infant.

TABLE 10
Questionnaire Responses

| | | | |
|---|---|---|---|
| | Lactose- | | |
| Question | free | Control | p-value |

Intake Items

| | | | |
|---|---|---|---|
| Spit-up with feedings, never or rarely, % | 72 | 50 | 0.002 |
| Frequent burping, never or rarely, % | 51 | 34 | NS |
| Vomited after feeding, never or rarely, % | 93 | 86 | NS |

Analysis combines data from Study Visit 2 (28 days) and Early Exit
NS, not significant

The primary conclusion reached in this study is that the substitution of alternate carbohydrate in the place of lactose—in this case a combination of corn syrup, rice starch and sucrose, can offer relief from spit-up in normal infants.

### EXPERIMENT 2

A clinical study of ready-to-feed (RTF), milk protein-based term infant formula with (carbohydrate as 100% lactose) or without lactose (carbohydrate as 55% corn syrup solids & 45% sucrose) in normal term infants.

The primary intent of this controlled, blinded, randomized, multi-centered study was to evaluate growth and formula tolerance of healthy term infants fed a cow milk-based formula without lactose as compared to a cow milk-based formula that contains lactose.

The primary outcome variable was growth as measured by the average daily weight gain from Days 8 to 112 of age. Formula tolerance, including incidence of spit-up and/or vomit, stool consistency, color and odor; and selected serum biochemistries were also assessed. Other secondary variables included weight, length, and head circumference.

The control study formula was a standard commercial milk-protein based formula containing lactose as the only source of carbohydrate (L). It was a formulation sold as Similac® With Iron, SWI (Ross Products, Columbus, Ohio). The investigational formula was similar to the control formula except that it was lactose-free (LF) and contained a mixture of corn syrup solids and sucrose as 55% and 45% (respectively) of total carbohydrate. This formula was later commercially introduced as Similac® Lactose-free (Ross Products, Columbus, Ohio).

The key nutrient compositions of the study formulas are shown in Table 11 below. All formulas were packaged in 32 fl oz cans and met or exceeded the minimum levels of nutrients recommended by the American Academy of Pediatrics/Committee on Nutrition (AAP/CON).

TABLE 11
Key Nutrient Compositions of Study Formulas (per Liter)

| | Lactose-free | Control |
|---|---|---|
| | (LF) | (L) |
| Nutrients | | |
| Protein, g | 15.3 | 14.8 |
| Source | Total Milk Protein | Non-fat Milk |
| Fat, g | 37.7 | 37.1 |
| Source | Soy & Coconut Oils | Soy & Coconut |
| | (60% & 40%) | Oils (60%:40%) |
| Carbohydrate, g | 70.0 | 72.3 |
| Source | Corn Syrup Solids/ | Lactose (100%) |
| | Sucrose (55/45%) | |
| Minerals | | |
| Calcium, mg | 691 | 545 |
| Phosphorus, mg | 452 | 453 |
| Magnesium, mg | 68.9 | 62.9 |
| Iron, mg | 14.7 | 13.1 |
| Vitamins | | |
| A, IU | 2182 | 3420 |
| D, IU | 406* | 406* |
| E, IU | 21.6 | 23.8 |
| C, mg | 134 | 149 |

Values are analytical values except those followed by asterisk (*), which are label claims.

Healthy term infants were enrolled at 8 days (±1 day) of age and were randomly assigned to receive either of the study formulas. Infants were fed the assigned study formulas as the only source of milk nutrition until 4 months of age. Infant tolerance to the formula was determined by evaluating formula intake (volume and frequency), occurrence of spit-up/vomit, and stool numbers and characteristics at 2, 8, 12, and 16 weeks of age. As a measure of growth, weight, length and head circumference of infants at birth were collected from hospital records and also measured at study entry, 2, 4, 8, 12, and 16 weeks of age. Selected serum biochemistries (urea nitrogen, albumin, calcium, phosphorus, and alkaline phosphatase) were determined at 8 and 16 weeks of age.

The Statistical test of the hypothesis for the primary variable was one-tailed; statistical tests of hypotheses on secondary variables were two-tailed. Differences were considered significant at the 0.05 level. Primary analyses were reported on an “intent-to-treat” basis; i.e., including all available data on all randomized subjects. Average number of feedings per day, intake per day and intake/kg/day were assessed using repeated measures analysis of variance. Analysis of variances was utilized in evaluating percent of feedings with spit-up and/or vomit. Where necessary, data was transformed using arcsine of the square root.

One hundred twenty-eight (128) healthy term infants were enrolled in this study; 63 were in the LF group and 65 in the L group. No differences were noted between the two study formula groups for most of the study entrance information including age at entry, ethnicity, gender, and gestational age and weight at birth.

Study early termination rates and those due to intolerance to assigned study formula can be important indicators of subjects tolerance to a study formula. There were 12 infants in the LF group and 19 in the L group who exited the study early. Study dropout rates were 19% for LF and 29% for L groups. Dropout rates due to intolerance to LF and L were 11% and 21.5%, respectively. There were, however, no statistically significant (p>0.05) differences in study exit classification between study groups.

No significant differences were observed in the average daily weight gains between the two study groups when the null hypothesis was tested by using a one-tailed test (P=0.895). However, when a two-tailed test was used to test the null hypothesis as a secondary analysis, females fed LF had a significantly (P=0.0203) higher (15%) daily average weight gain throughout the study than females fed L. Weight was not significantly different among the groups regardless of gender. There were also no significant differences noted between the two studies formula groups for length, head circumference, weight, length, head circumference and weight for length, regardless of gender. Mean serum biochemistry values for both LF and L groups were within the normal ranges for infant. Thus, growth and serum biochemistries were normal and similar in both study formula groups. Additionally, the frequency of feeding and the average daily intake of study formulas were not significantly different.

Data was collected regarding the percent of feedings with associated spit-up and/or vomit at five intervals (2, 4, 8, 12, and 16 weeks of age). As shown in Table 12 below, there was a substantially smaller frequency of spit-up/vomit reported for LF at every interval. Only the data for the first two intervals were subjected to complete statistical analysis. The difference observed at 2 weeks of age approached statistical significance with a p value of 0.0559; while the 4-week p value was higher. The subsequent data points were not statistically analyzed, but a trend at 8, 12, and 16 weeks of age towards reduced spit-up frequency is clear.

TABLE 12
Occurrence of Spit-up and/or Vomit as a Percentage of Feeding^{†}

| Percentages of Feeding with | Lactose-free | Control |
|---|---|---|
| Spit-up and/or Vomit | (LF) | (L) |
| 2 weeks of Age | 15.8 ± 2.0 | 21.0 ± 2.6 |
| 4 weeks of Age | 12.0 ± 1.7 | 15.0 ± 2.4 |
| 8 weeks of Age | 13.2 ± 2.8 | 18.9 ± 3.0 |
| 12 weeks of Age | 9.7 ± 2.5 | 21.2 ± 3.5 |
| 16 weeks of Age | 15.5 ± 2.9 | 24.5 ± 7.7 |

^{†}Value are mean ± SEM

The primary objective of this study was to demonstrate that a formulation of milk-based lactose-free formula (LF) would be efficacious in supporting normal growth in term infants. A standard, proven, milk-based, lactose-containing commercial formula, Similac® with Iron (L) was used as the control formula for this comparison. The results of this study demonstrated that growth was normal and generally similar in infants fed LF and L. Thus, this study suggested that a lactose-free formula would support normal growth of healthy term infants as a sole source of milk nutrition. In addition, the study suggested that a lactose-free formula was better tolerated versus a standard lactose milk-based formula as indicated by a consistent trend in reducing spit-up and/or vomit occurrence, and lower study dropout due to perceived formula intolerance in term infants.

### EXPERIMENT 3

A clinical study of powdered milk-protein based, nutrient-and energy-enriched, lactose-reduced, preterm infant formula (carbohydrate as 50% corn syrup solids % 50% lactose) versus term infant formula (carbohydrate as 100% lactose).

The primary objective of this double-blind, prospective, parallel, randomized study was to determine whether a nutrient- and energy-enriched formula containing a reduced lactose carbohydrate blend (50% reduction) designed for preterm infant feedings after hospital discharge would enhance the growth of these infants over the first year of age. Additional objective was to determine if this formula would be tolerated by these infants.

The primary variables were weight, length, and head circumference and gains in these measures. Secondary objectives included acceptance of and tolerance to the formulas as measured by the volume of formula intake, incidence of spit-up or vomit; stool characteristics such as stool color and consistency; bone mineral content (BMC) and density (BMD) using Dual Energy X-Ray Absorptiometry (DXA); and selected serum biochemistries.

The reduced lactose carbohydrate blend designed for preterm infants (marketed as NeoSure®, 22 kcal/fl oz; Ross Products, Columbus, Ohio) or a standard formula for term infants containing lactose as 100% carbohydrate (Similac® With Iron, (SWI), as commercially available in 1994 to 1997; 20 kcal/fl oz; Ross Products, Columbus, Ohio) was compared.

Preterm infants were enrolled into the study 2 to 4 days before expected hospital discharge, which typically occurred when a body weight of ˜1800 g had been attained. At enrollment, infants were randomized receive either, SWI or NeoSure®. Randomization was stratified by gender and birth weight group (≦1300 g and >1300 g). Members of sets of twin or triplet infants were assigned to the same formula group. The ready-to-feed (RTF) forms of the study formulas were fed between enrollment and hospital discharge and the powdered forms were fed from hospital discharge to 52-weeks, corrected age (CA). Parents were instructed to feed the study formulas as the sole dietary source from hospital discharge to 16-weeks CA, after which solid foods were also permitted.

At enrollment, weight, length, and head circumference measurements were obtained. Weight was measured daily through day of discharge. At each of the subsequent clinic visits, weight, length and head circumference were again measured. The volume of formula intake and information about feeding tolerance (frequency of vomiting and spit-up) and stool patterns (e.g., color, consistency) were recorded by the parents on forms provided by the sponsor for 3 days prior to each study visit. Bone mineralization was determined by DXA at study day (SDAY) 1 (baseline) and at 16- and 52-weeks CA. Blood samples were obtained at study entry and at the 16- and 52-weeks CA visits. Blood hemoglobin levels and serum levels of transthyretin, albumin, retinol binding protein, calcium, phosphorus, and alkaline phosphatase were determined. The levels of key nutrient for study formulas are shown in Table 13 below. The study formulas differed in the sources of protein, carbohydrate and fat and amount of minerals and total energy. NeoSure® contained protein from non-fat milk and whey protein concentrate and SWI from non-fat dry milk. NeoSure® contained 50% lactose and 50% corn syrup solids (maltodextrose), and SWI contained 100% lactose. The NeoSure®) fat blend was 45% soy, 30% coconut and 25% medium chain triglyceride oil while the SWI fat blend was 60% soy and 40% coconut oil. NeoSure® contained higher levels of most vitamins and minerals per 100 kcal than SWI. The nutrient composition of all formulas met the levels established by the American Academy of Pediatrics, Committee on Nutrition (AAP-CON) as regulated by the Infant Formula Act of 1980 and the subsequent amendment enacted in 1986.

TABLE 13
Nutrient Composition of Powdered
Study Formulas (per Liter, as fed)

Study Formulas

| | NeoSure ® | Control |
|---|---|---|
| Nutrient | (Reduced Lactose) | (100% Lactose) |
| Protein, g | 20.2 | 15.3 |
| Source | Nonfat milk & Whey | Nonfat milk |
| Fat, g | 41.7 | 37.0 |
| Source | Soy/HOSO/Coconut/MCT | Soy/Coconut |
| | (28/27/20/25%) | (60/40%) |
| Carbohydrate, g | 75.2^{‡} | 70.45^{‡} |
| Source | Corn Syrup Solids/ | Lactose (100%) |
| | Lactose (50/50%) | |

Minerals

| | | |
|---|---|---|
| Calcium, mg | 850 | 535 |
| Phosphorus, mg | 498 | 445 |
| Magnesium, mg | 82.9 | 52 |
| Iron, mg | 14.8 | 13.2 |

Vitamins

| | | |
|---|---|---|
| A, IU | 4356 | 3379 |
| E, IU | 29.8 | 23.3 |
| C, mg | 258 | 152.3 |
| D, IU | 595^{†} | 410^{†} |
| Energy, kcal | 746^{‡} | 676^{‡} |

^{†}Represents label claim values
^{‡}Calculated using analytical values

Key comparisons for this study focused on differences in growth between the two study feeding groups. Statistical tests were two-tailed, with p<0.05 considered statistically significant. Anthropometric measures for SDAY 1 and each subsequent visit, as well as gains between visits and over the study period, were evaluated using ANOVA controlling for gender and birth weight stratum (<1300 g, ≦1300 g). The volume of formula intake, the frequency of spitting-up and vomiting, and information about stool patterns were analyzed using Student's t-test or Fisher's exact test as appropriate.

Fifty-six (56) infants were enrolled and 47 infants completed the study through 12-months of age. Four of the 29 infants randomized to the NeoSure group and five of the 27 infants randomized to SWI exited the study before the study visit at 16-weeks CA. There were no significant differences between groups for status at exit (completed vs. did not complete), infant and family demographics, gestational age and anthropometric measurements at birth, gender, gestational appropriateness, and clinical histories. The majority of infants were Caucasian with about 60% from twin or triplet births. At enrollment, the distribution of infants across the birth weight strata (<1300 g, ≦1300 g) was similar. About 40% of the infants had birth weights of 935-1299 g and 60% had birth weights of 1300-1750 g.

Weight, length, and head circumference at each of the study visits did not differ between the NeoSure® and SWI groups. There were no differences between formula study groups for growth, biochemical measures of protein (albumin, transthyretin, retinol binding protein) and mineral status (calcium, phosphorus, alkaline phosphatase, hemoglobin) or bone mineralization. Formula intake was consistently greater for infants fed SWI than those fed NeoSure® through 40-weeks CA. Increased formula intake ad libitum in infants fed SWI with lower energy density than NeoSure® suggests that there are compensatory responses to energy and/or nutrient density in the infant diet. The number of feedings per day however was not different between the NeoSure® and SWI groups, except at 4-weeks CA (6.2±0.2 vs. 7.0±0.2 feedings/day, respectively). The mean stool rank consistency, an index on which stool consistency is scaled from 1 (watery) to 5 (hard), was not different between groups except at one of the four time points. At 4-weeks CA, infants fed SWI had slightly firmer stools.

TABLE 14
Percent of Feedings with Spit-up and/or Vomit

| | NeoSure ® | Control (SWI) | p-Value |
|---|---|---|---|
| Term | 21 ± 6* | 32 ± 7 | NS |
| 4 weeks CA | 22 ± 6 | 35 ± 7 | 0.0469 |
| 8 weeks CA | 18 ± 5 | 30 ± 8 | NS |
| 16 weeks CA | 18 ± 6 | 33 ± 8 | NS |
| 26 weeks CA | 10 ± 3 | 32 ± 8 | 0.0205 |
| 40 weeks CA | 1 ± 1 | 2 ± 1 | NS |
| 52 weeks CA | 0 ± 0 | 5 ± 2 | 0.0133 |

*Unadjusted mean ± SEM
Abbreviations: CA, corrected age.

Clearly, spit-up and/or vomit (see Table 14) occurred more frequently in the group of infants fed SWI than in the NeoSure® fed group at each time point throughout the study. The occurrence of spit-up and/or vomit as a percent of feeding achieved statistical significant difference at the 4-, 26- and 52-week CA visits, although not at other time points.

This study provided evidence that NeoSure® supports growth of preterm infants from hospital discharge to 12 months CA. The reduced incidence of spit-up and/or vomit in infants fed NeoSure® when compared to those fed SWI suggests that NeoSure® is better tolerated by the preterm infants.

### EXPERIMENT 4

A clinical study of ready-to-feed (RTF), milk-protein based term infant formula with (carbohydrate as 100% lactose) or without lactose (carbohydrate as 60% rice syrup and 40% sucrose).

A controlled, blinded, randomized, multi-centered 16-week parallel feeding study was conducted in 89 healthy term infants to compare and evaluate the growth and tolerance of healthy term infants fed a milk protein, lactose-free experimental product with that of infants fed previous formulation of Similac® With Iron (Ross Products, Columbus, Ohio) containing 100% lactose. Infant growth, as measured by weight, length, and head circumference, and selected serum biochemistries (serum calcium, phosphorus, alkaline phosphatase, and albumin at 8 and 16 weeks) were the primary outcome variables. Secondary outcome variables included additional serum biochemistry analyses, tolerance to the formulas as assessed by records of dietary intake, incidence of spitting up or vomiting, and stool information The lactose-free (LF) investigational formula in RTF form containing 60% rice syrup (maltodextrin) and 40% sucrose carbohydrate blend. The commercialized formulation of Similac® With Iron (SWI) containing 100% lactose in RTF form served as the control. Both study formulas met or exceeded the minimum levels of nutrients recommended by the American Academy of Pediatrics/Committee on Nutrition (AAP/CON). Levels of key nutrients in the study formulas are in Table 15 below.

TABLE 15
Composition of Clinical Products (per liter)

| | Lactose-free Formula | | Control | |
|---|---|---|---|---|
| | (LF) | | (SWI) | |
| | Batch 1 | Batch 2 | Batch 1 | Batch 2 |
| Protein, g | 15.65 | 15.63 | 14.9 | 14.8 |
| Source | milk protein isolate | | non-fat milk | |
| Fat, g | 36.5 | 37.8 | 37.2 | 37 |
| Source | high-oleic safflower, coconut, | | soy & coconut oil | |
| | soy oil | | | |
| Carbohydrate, g | 70.0 | 70.0 | 72.3 | 72.3 |

| | | |
|---|---|---|
| Source | rice maltodextrin, sucrose | lactose |

Minerals

| | | | | |
|---|---|---|---|---|
| Calcium, mg | 693.1 | 771.7 | 573.4 | 535 |
| Phosphorus, mg | 435.7 | 464 | 447.8 | 431 |
| Magnesium, mg | 78.7 | 76.2 | 67.7 | 63.7 |
| Iron, mg | 13.3 | 14.3 | 13.9 | 13.5 |

Vitamins

| | | | | |
|---|---|---|---|---|
| Vitamin A, IU | 2,647 | 2,490 | 2,774 | 2,486 |
| Vitamin D, IU | 434 | NA | 440 | 440 |
| Vitamin E, IU | 22.35 | 22.3 | 22 | 22.4 |
| Vitamin C, mg | 148.3 | 128.6 | 122 | 196 |

Infants between birth and 14 days of age were randomly assigned to receive one of the two formulas for the entire course of the study. Each was examined prior to receiving formula and at 2, 4, 8, 12 and 16 weeks age. At all visits except weeks 3-4, a 3-day record of dietary infant and stool information was collected. During the third week, a 7-day record of infant tolerance (dietary intake, incidence of spitting up or vomiting stool number and characteristics) was collected. Weight, crown-heel length, and head circumference were collected from hospital records and measured at each visit (2, 4, 8, 12 and 16 weeks of infant age).

Intake, stool characteristics, and spit-up/vomit frequency were evaluated for each study feeding period and follow-up using t-tests on the ranked data and Fisher's exact tests for predominant characteristics. Intake volume was also analyzed for each gender. Feeding and stool pattern questionnaire responses were evaluated using Fisher's exact tests and t-tests. Serum chemistries were analyzed using t-tests on the ranked data. All hypothesis testing was two-sided; P<0.05 was considered a significant result.

Eighty-nine (89) infants were enrolled in the clinical trial, 45 received SWI and 44 received LF. Seven infants fed LF were removed from the study due to intolerance to the formula. One infant fed SWI and three fed LF were protocol failures, none were related to the tolerance of the study formula.

There were no significant differences between study groups for any other anthropometric comparisons at birth, gestational appropriateness, 5 minute Apgar score or ethnicity. There were no significant differences in growth (weight, length, or head circumference) or in the number of feeds per day between feeding regimens at any study visit.

As can be seen in Table 16 below, frequency of spitting-up as a percent of feedings was lower in the LF group than the SWI group at every time point during the 16 weeks study, however, p-values of <0.05 were not achieved for differences observed at any visit.

TABLE 16
Percent of Feedings with Spit-up (mean ± SEM)

| Formula | | | | | |
|---|---|---|---|---|---|
| Group | Week 2 | Week 3 | Week 8 | Week 12 | Week 14 |
| Control | 20.8 ± 3.8 | 15.5 ± 3.7 | 17.4 ± 3.9 | 19.1 ± 3.9 | 17.2 ± 3.6 |
| LF | 12.8 ± 3 | 13 ± 3.6 | 12.4 ± 4.1 | 12 ± 3.5 | 12.6 ± 3.8 |

A lactose-free formula (LF) containing milk protein promoted normal growth and development of healthy term infants. Furthermore, this Lactose-free formula had consistent lesser tendency to promote spit-ups in term infants.

### EXPERIMENT 5

A clinical study of an experimental lactose-free (sucrose & rice maltodextrin carbohydrate), rice-protein based powdered formula compared with a standard milk-protein based powdered formula containing lactose, Similac® with Iron (Ross Products, Columbus, Ohio).

The objective of this randomized, parallel study was to evaluate the growth, formula tolerance, and selected serum biochemistries of healthy term infants fed an investigational lactose-free, rice protein-based powdered formula (Rice) when compared to Similac® with Iron (SWI), a standard milk-protein based, powdered formula containing lactose as 100% of carbohydrate during the first 16 weeks of life.

Primary study variables included infant weight and select serum biochemistries (calcium, phosphorus, alkaline phosphatase, albumin, prealbumin, BUN, and plasma amino acids). Other measures such as incidence of spit-up as a percent of feeding, anthropometrics, formula volume intake, and stool patterns were considered secondary variables. All evaluations were performed at study entry, 2, 4, 8, and 16 weeks of feeding except serum biochemistries which were only obtained at study entry, 4, 8, and 16 weeks of feeding.

The study formulas were (a) commercial Similac® with Iron (SWI) powder containing 100% carbohydrate as lactose, and (b) the investigational lactose-free, rice protein-based formula powder. The composition and key ingredient list for each of the formulas are given in Table 17 below.

TABLE 17
Composition of Study Formulas (per liter)¹

| Nutrient | Control | Rice |
|---|---|---|
| Protein, g | 15.04 | 19.10 |
| Source | cow's milk | rice protein |
| Fat, g | 37.7 | 37.9 |
| Source | soy and coconut | soy, coconut and |
| | oils | HO-safflower oils |
| Carbohydrate, g | NA (72.3) | 66.9 |
| Source | lactose | Rice syrup (60%), |
| | | sucrose (40%) |
| Calcium, mg | 540 | 927 |
| Phosphorus, mg | 442 | 567 |
| Magnesium, mg | 53.7 | 58.1 |
| Iron, mg | 13.3 | 11.5 |
| Vitamin A, IU | 3,391 | 2381 |
| Vitamin D, IU | NA (400) | 434 |
| Vitamin E, IU | 24.1 | 21.4 |
| Vitamin K, mcg | NA (55) | NA (100) |
| Vitamin C, mg | 152 | 134 |

¹All are analyzed values except where indicated with NA
NA = not analyzed, label claim values are in parenthesis

Study formulas were provided in clinically labeled cans and provided 20 kcal/fl oz when formula was prepared as indicated. The nutrient levels in both formulas met the minimum nutrient levels recommended by the Committee on Nutrition of the American Academy of Pediatrics. Comparatively, the Rice formula was about 27% higher in protein than the SWI formula. The source of protein for SWI was non-fat dry milk, whereas that for the Rice formula was a rice protein concentrate. Because rice protein is limiting in lysine and threonine, it was supplemented with 36.5 mg lysine/g protein and 15.7 mg threonine/g protein. Fat levels in both formulas were similar, but fat sources were soy and coconut oils for the SWI formula and soy, coconut, and high-oleic safflower oils for the Rice formula. Carbohydrate sources were lactose for the SWI formula and rice syrup and sucrose for the Rice formula.

In this study, all statistical tests were two-sided with significant differences defined as p<0.05. Anthropometric measures were analyzed using one-way ANOVA for feeding group effects at each time point. Intake volumes, number of feedings, and stools per day were analyzed using one-way ANOVA for feeding. Mean rank stool consistency, stool characteristics, spit-up and/or vomit occurrence were analyzed at each study visit using the one-way ANOVA of ranked data.

Eighty (80) healthy, term infants were enrolled and 65 infants completed the study (SWI=33, Rice=32). There were 2 treatment failures, 1 in each formula group, and 13 protocol failures, 6 in the SWI group and 7 in the Rice group. There were no differences in the number of infants who completed the study in regard to gender, race, or characteristics of infants at the beginning of the study.

Formula and energy intakes were similar between the two groups and there were no differences in the average number of feedings per day. As expected, protein intake was higher in the Rice group than the SWI group as the protein content of the Rice formula was about 27% higher than that of the SWI formula.

The data indicated that infants grew well the rice formula comparable to SWI. The weight, length, and head circumference of infants fed the Rice and SWI formulas were generally similar. Weight gains were lower in females for the Rice group than in the SWI group at Weeks 2 and 4 of feeding; however, weight gains were similar by Week 8 until the end of the study. Length of infants was slightly (but not statistically significant) greater in the Rice group than the SWI group. Serum biochemistries were similar between the two groups except for the BUN levels, which were higher in the SWI group at Weeks 4 and 8, but were similar at Week 16. For serum amino acids, the SWI group had higher levels of almost all essential amino acids than the Rice group. The only exception was threonine, for which the Rice group had a significantly greater amount than the SWI group. The magnitude of these differences decreased as feeding progressed. The amino acid levels in both groups appeared normal.

The two formulas were tolerated similarly. However, the occurrences of spit-up and/or vomit were fewer in the lactose-free (Rice) group than the SWI group at 4, 8, and 16 (see Table 18). The reduction in spit-up and/or vomit for the Rice versus SWI group achieved statistical significance (p<0.05) at 4 weeks of feeding.

TABLE 18
Occurrence of Spit-up and/or Vomit¹

| Variables | Week | Control | Rice | p Value |
|---|---|---|---|---|
| Spit-Up and/or | 2 | 18.8 ± 5.6 | 19.2 ± 4.5 | NS |
| Vomit Occurrence, | 4 | 31.6 ± 5.6^{a} | 16.3 ± 4.7^{b} | 0.01 |
| (% of Feeding)² | 8 | 37.6 ± 6.9 | 28.4 ± 5.3 | NS |
| | 16 | 27.8 ± 6.0 | 19.9 ± 4.9 | NS |

¹Mean ± SEM
²Means for variables with different superscripts are different at Week 4 of Feeding (p < 0.05)
NS = No significant (p > 0.05)

The results of this study demonstrated that general formula tolerance and growth of infants fed the investigational lactose-free, rice-based formula are good and comparable to those of infants fed a standard milk-protein based formula containing lactose. The study also suggested, however, that the lactose-free, rice-based formula could be helpful in reducing the incidence of spit-up in term infants.

### EXPERIMENT 6

A clinical home-use-test (HUT) of tolerance and acceptability of liquid concentrate and powdered lactose-free, milk-protein based formulas with different carbohydrates in term infants.

The objectives of this multi-center, parallel, randomized, partially masked, home-use-feeding study were to evaluate the relative tolerance and acceptability of lactose-free, milk-protein based infant formulas (two concentrated liquids, CL; and one powder, PWD) with different carbohydrate blends. Additionally, this study was conducted to determine perturbations in tolerance (in a normal infant population) as a result of switching from a standard cow's milk-based formula containing lactose to any of the three study formulas that do not contain lactose.

The mean stool consistency rating (watery, loose/mushy, soft, formed, hard) was the primary outcome comparison variable. Also of interest was the comparative stool consistency (firmness) rating between the prestudy formula (Similac® Ross Products, Columbus Ohio[S]) and each of the three study formulas and other tolerance measures such as occurrence of spit-up, gassiness, and fussiness.

The study was conducted in healthy, term infants from 2 to 12 weeks of age consuming Similac® (S) formula at study entry were randomized to receive one of three study formulas for a minimum of a 7 day feeding period. Two of the three lactose-free formulas were concentrated liquid (CL) and one was powder (PWD).

The study formulas were (1) commercially available Enfamil LactoFree concentrated liquid (Mead Johnson, Evansville, Ind.), (ELF-CL); (2) Similac® Lactose-free concentrated liquid (Ross Products, Columbus Ohio), (SLF-CL); and (3) Similac® Lactose-free powder (Ross Products, Columbus Ohio), (SLF-PWD). The compositions and key nutrients of the study formulas are shown in Table 19. All formulas provided 20 kcal per fl oz on reconstitution and met or exceeded minimum levels of nutrients as recommended by the Committee on Nutrition of the American Academy of Pediatrics and the Infant Formula Act, 1980, and the subsequent amendments, 1986.

TABLE 19
Key Nutrient Composition of Prestudy and Study Formulas (per 100 kcal)¹

| Nutrient | Control (S) | ELF-CL | SLF-CL | SLF-PWD |
|---|---|---|---|---|
| Protein, g | 2.07 | 2.1 | 2.14 | 2.14 |
| Source | nonfat milk | milk protein isolate | milk protein | milk protein |
| | | | isolate | isolate |
| Fat, g | 5.40 | 5.3 | 5.40 | 5.40 |
| Source | high oleic | palm olein, | soy, coconut | high oleic |
| | safflower, | coconut, soy, high | oil | safflower, |
| | coconut, soy oils | oleic sunflower oils | | coconut, soy oils |
| Carbohydrate, g | 10.8 | 10.9 | 10.7 | 10.7 |
| Source | lactose | corn syrup solids | corn syrup | corn syrup solids |
| | | | solids | & sucrose |
| | | | & sucrose | |

Minerals

| | | | | |
|---|---|---|---|---|
| Calcium, mg | 78 | 82 | 84 | 84 |
| Phosphorus, mg | 42 | 55 | 56 | 56 |
| Magnesium, mg | 6 | 8 | 6 | 6 |
| Iron, mg | 1.8 | 1.8 | 1.8 | 1.8 |

Vitamins

| | | | | |
|---|---|---|---|---|
| A, IU | 300 | 300 | 300 | 300 |
| D, IU | 60 | 60 | 60 | 60 |
| E, IU | 1.5 | 2.0 | 3.0 | 3.0 |
| C, mg | 9.0 | 9.0 | 9.0 | 9.0 |

¹Nutrient levels are based on Label Claims

After an infant was enrolled at a participating pediatrician's office, the parents were contacted by telephone by a marketing research company to confirm willingness to participate. The assigned study formula was shipped to the family. Parents were contacted by telephone approximately 14-28 days after formula shipment to obtain information on the infants' tolerance and acceptability of the assigned formula. Overall, statistical analyses were based on the intent-to-treat basis and statistically significant at the 5% level.

All the three study formulas were well tolerated by the infants (Table 20). Over 85% of respondents said that their infant tolerated SLF-CL and SLF-PWD very or somewhat well; and about 80% of respondents claimed their infant tolerated EFL-CL very or somewhat well.

TABLE 20
How Baby Tolerates/Accepts Formula

| | ELF-CL | SLF-CL | SLF-PWD |
|---|---|---|---|
| Very/Somewhat Well (net) | 80% | 89% | 85% |
| Very Well | 58 | 70 | 65 |
| Somewhat Well | 22 | 19 | 20 |

Note:
no significant differences at the 95% confidence level

Parents were asked to compare their infant's response to the study formula relative to the responses to the pre-study formula (S). When queried as to whether the infant experienced less spit-up from the lactose-free formula as compared to the pre-study formula, many positive response were obtained (Table 21). Both Similac® Lactose-free Formulas (SLF-CL and SLF-PWD) had greater reduction in spit-up than ELF-CL. SLF-CL demonstrated statistically significant (p<0.05) reduced spit-up compared to ELF-CL.

TABLE 21
Compared to Prestudy Formula, Baby Experienced Less . . .

| | ELF-CL | SLF-CL | SLF-PWD |
|---|---|---|---|
| Spit-up | 22% | 41% | 37% |

Note:
SLF-CL significantly different from ELF-CL at the 95% confidence level (p < 0.05).

This study suggested that all commercially available lactose-free formulations tested were well tolerated and provided reduced spit-up when compared to the prestudy formula which contained lactose; although, SLF-CL was associated with greater reduction. Thus, the study suggested that spit-up occurrence is reduced by lactose-free formula feeding in infants compared to a lactose containing formula when milk-protein based formulas are fed irrespective of the alternative carbohydrate blends.

### EXPERIMENT 7

A clinical tolerance pilot study of an experimental lactose-free (sucrose & rice maltodextrin carbohydrate), rice-protein based powdered formula compared with a standard milk-protein based powdered formula containing lactose, Similac® with Iron in healthy term and preterm infants.

The objective of this pilot study was to evaluate the effects of an experimental lactose-free rice-protein based formula (Rice) versus Similac® with Iron, a milk-based formula (SWI), on formula tolerance and stool characteristics in healthy infants.

This was a blinded 4-week (two 2-week periods) controlled, randomized, two-way crossover study of an experimental lactose-free rice-protein based formula (Rice) versus Similac® with Iron (SWI) in healthy infants. Upon entrance to the study, infants were assigned either clinically labeled SWI powder or an experimental lactose-free Rice-protein based powder formula. Infants consumed their assigned dietary regimen for 2 weeks and then switched to the alternate feeding for 2 weeks.

The study feedings were 1) SWI powder and 2) an experimental lactose-free rice-protein based powdered formula. The composition of key nutrients is given in Table 22. Study formulas were provided in clinically labeled cans and provided 20 kcal/fl oz when prepared as indicated. The nutrient levels in all formulas met the nutrient levels recommended by the Committee on Nutrition of the American Academy of Pediatrics.

TABLE 22
Key Nutrient Composition of Study Formulas (per liter as fed)

| Nutrient | Control (SWI) | Rice |
|---|---|---|
| Protein, g | 15.04 | 19.10 |
| Source | cow's milk | Rice protein |
| Fat, g | 37.7 | 37.9 |
| Source | soy and coconut oils | soy, coconut and HO-safflower |
| | | oils |
| Carbohydrate, g | NA (72.3) | 66.9 |
| Source | lactose | Rice syrup and sucrose |
| Calcium mg | 540 | 927 |
| Phosphorus, mg | 442 | 567 |
| Magnesium, mg | 53.7 | 58.1 |
| Iron, mg | 13.3 | 11.5 |
| Vitamin A, IU | 3391 | 2381 |
| Vitamin D, IU | NA (400) | 434 |
| Vitamin E, IU | 24.1 | 21.4 |
| Vitamin C, mg | 152 | 134 |

NA = not analyzed, label claim values are in parenthesis

A total of 11 healthy infants were enrolled in this study. There were 9 study protocol completers and 2 protocol failures due to parental withdrawal of infants. Two of 9 study completers were pre-term infants. The average age of completers at study entrance was 131±26 days

The primary study variables included formula tolerance (spit-up and/or vomit occurrence) and stool characteristics (stool consistency, number of stool per day, etc.). Formula intake, weight and stool survey responses were secondary variables.

The Student's t-Test for parametric variables and the Wilcox on Two-Sample Test for non-parametric variants were used in testing for an equal carryover effect. When an unequal carry-over effect was not indicated, data from the two-phases of the crossover were utilized to test for the feeding regimen differences. When an unequal carry-over effect was indicated, only the data from the first phase were used. The critical p-value used was 0.05.

Both groups had similar numbers of feeding per day, but Rice-fed infants had a lower intake of formula and calories, and a higher intake of protein than SWI-fed infants because Rice formula was higher in protein. The Rice-based formula and SWI were otherwise similarly tolerated as indicated by the absence of significant differences (p>0.05) between infants fed Rice and SWI formulas for the occurrence of rashes, runny nose, fussiness and occurrence of non-typical days. Rice-fed infants had a significantly higher average number of stools per day (1st 3-day period), a higher mean stool consistency rank (2nd 3-day period) than the SWI-fed infants. The Rice-fed infants tended to produce formed/hard stools whereas the SWI-fed infants tended to produce soft/mushy stools. These observations may be due to the fact that the Rice protein concentrate used in the Rice formula contains some fiber.

The occurrence of spit-up and/or vomit as a percent of feeding was slightly less for the Rice-fed infants (Table 23). However, the difference was not statistically significant (p>0.05).

TABLE 23
Spit-Up and/or Vomit Occurrence as a Percentage of Feedings

| | Control (SWI) | Rice |
|---|---|---|
| First 3-Day Period¹ | 42.3 ± 10.8 | 37 ± 10.4 |
| Second 3-Day Period | 42.3 ± 13.6 | 29.9 ± 11.3 |

¹1st period > 2nd Period for Rice (p < 0.05)

This study demonstrated that infants tolerate an experimental lactose-free, rice-protein based formula and produce a satisfactory stool pattern. Additionally, the lactose-free, rice-protein based formula showed a tendency to reduce spit-up and/or vomit in infants both term and preterm infants.

We claim:

1. A method for reducing regurgitation in infants comprising feeding said infant a non-soy-protein-based infant formula in which the lactose content of said formula constitutes 75 w/w %, or less, of the carbohydrate component.

2. The method according to claim 1 in which said lactose constitutes 50 w/w %, or less, of said carbohydrate component.

3. A method for reducing regurgitation in an infant in need thereof comprising feeding said infant a formula containing, per 100kcal:
a) About 1 to 3.5 grams of a source of protein obtained from non-soy proteins;
b) About 3 to 8 grams of a source of lipid, and;
c) About 8 to 16 grams of a source of carbohydrate, in which no more than 75 w/w % of said carbohydrate is lactose.

4. The infant formula according to claim 3 in which said source of carbohydrate contains at most 50 w/w % of lactose.

5. The infant formula according to claim 3 in which said source of carbohydrate contains at most 10 w/w % of lactose.

6. The method according to claim 3 in which said source of carbohydrate is lactose-free.

7. The infant formula according to claim 3 in which said source of protein is obtained from milk-based proteins.

8. An article of manufacture comprising the infant formula of claim 3 in which said article bears a legend stating that the infant formula is suitable for infants experiencing spit-up.

9. An article of manufacture comprising the infant formula of claim 3 in which said article bears a legend stating that the infant formula will reduce the incidence of spit-up in an infant afflicted with said condition.

10. An infant formula comprising, based on a 100 kcal basis:
a) about 1 to 3.5 grams of a source protein obtained from non-soy proteins;
b) about 3 to 8 grams of a source of lipid;
c) about 8 to 16 grams of an admixture of carbohydrates,
i. in which no more than 75 w/w % of said admixture is lactose, and;
ii. said admixture includes a sufficient quantity of a viscosity increasing agent.

11. The infant formula according to claim 10 in which said admixture contains at most 50 w/w % of lactose.

12. The infant formula according to claim 10 in which said admixture contains at most 10 w/w % of lactose.

13. The infant formula according to claim 10 in which said admixture is lactose-free.

14. The infant formula according to claim 10 in which said source of protein is obtained from milk-based proteins.

15. The infant formula according to claim 10 in which said viscosity increasing agent is selected from the group consisting of locust bean gum, carob gum, xanthan gum, guar gum, alginate, konjac flour (glucomannan), beta-glucan, psyllium, carboxymethyl cellulose, fenugreek fiber, gum tragacanth, gum arabic, gellan gum, gum ghatti, gum karaya, furcellaran, gelatin, agar, pectin, carrageenan, microcrystalline cellulose and hydroxypropyl methyl cellulose.

16. The infant formula according to claim 10 in which said viscosity increasing agent is a starch selected from the group consisting of rice, corn, tapioca, potato, amaranth starch, milo starch, cassava starch, arrowroot starch, sago starch, amioca starch and green pea starch.

17. The infant formula according to claim 10 in which said viscosity increasing agent is present in a quantity sufficient to produce a ready-to-feed viscosity of at least 20 centipoise.

18. A method for reducing regurgitation in infants comprising feeding an infant in need thereof an infant formula according to claim 10.

19. A method for reducing regurgitation in infants comprising feeding an infant in need thereof an infant formula according to claim 17.

20. An article of manufacture comprising the infant formula of claim 10 in which said article bears a legend stating that the infant formula is suitable for infants experiencing spit-up.

21. An article of manufacture comprising the infant formula of claim 10 in which said article bears a legend stating that the infant formula will reduce the incidence of spit-up in an infant afflicted with said condition
